(19) United States
(12) Patent Application Publication
(10) Pub. No.: US 2022/0163340 A1
(43) Pub. Date: May 26, 2022

(54) SERVER APPARATUS, TERMINAL APPARATUS, MEDIUM, VEHICLE, AND METHOD OF OPERATING A SYSTEM

(71) Applicant: TOYOTA JIDOSHA KABUSHIKI KAISHA, Toyota-shi (JP)

(72) Inventors: Takashige HORI, Aisai-shi (JP); Masaru WAKABAYASHI, Nagoya-shi (JP)

(73) Assignee: TOYOTA JIDOSHA KABUSHIKI KAISHA, Toyota-shi (JP)

(21) Appl. No.: 17/527,639

(22) Filed: Nov. 16, 2021

(30) Foreign Application Priority Data
Nov. 26, 2020 (JP) 2020-196366

(51) Int. Cl. G01C 21/36; G01C 21/34

(52) U.S. Cl. CPC G01C 21/3605; G01C 21/3476; H04W 4/40; G01C 21/3492; G01C 21/3461

(57) ABSTRACT

A server apparatus includes a communication interface, a memory configured to store information on an area in which a terminal apparatus mounted in a vehicle can connect to a predetermined communication network, and a controller configured to transmit and receive information to and from the terminal apparatus via the communication interface. Upon receiving, from the terminal apparatus, information on a departure point and a destination of the vehicle and designation information designating a connection to the predetermined communication network, the controller is configured to transmit, to the terminal apparatus, information necessary for the terminal apparatus to output information on a first route from the departure point through the area to the destination.

### CROSS-REFERENCE TO RELATED APPLICATION

This application claims priority to Japanese Patent Application No. 2020-196366 (filed on Nov. 26, 2020), the entire contents of which are incorporated herein by reference.

### TECHNICAL FIELD

The present disclosure relates to a server apparatus, a terminal apparatus, a program, a vehicle, and a method of operating a system.

### BACKGROUND

A navigation apparatus capable of searching for a route in accordance with the wishes of a user of a vehicle and providing the search results is known. For example, patent literature (PTL) 1 discloses a navigation apparatus in which a user's wishes, such as distance, use of toll roads, and use of main roads, can be set as search conditions.

### CITATION LIST

### Patent Literature

PTL 1: JP 2011-43372 A

### SUMMARY

Technology to search for vehicle routes has room for improvement in convenience by satisfying a user's wishes in detail when the user's wishes vary widely.

It would be helpful to provide a server apparatus and the like that can increase convenience by performing a route search that satisfies a user's wishes in detail.

A server apparatus according to the present disclosure includes:

a communication interface;

a memory configured to store information on an area in which a terminal apparatus mounted in a vehicle can connect to a predetermined communication network; and

a controller configured to transmit and receive information to and from the terminal apparatus via the communication interface, wherein

upon receiving, from the terminal apparatus, information on a departure point and a destination of the vehicle and designation information designating a connection to the predetermined communication network, the controller is configured to transmit, to the terminal apparatus, information necessary for the terminal apparatus to output information on a first route from the departure point through the area to the destination.

A terminal apparatus according to the present disclosure includes:

a communication interface;

a controller configured to transmit and receive information, via the communication interface, to and from a server apparatus storing information on an area in which the terminal apparatus can connect to a predetermined communication network; and

an output interface configured to output information received from the controller, wherein

the controller is configured to transmit, to the server apparatus, information on a departure point and a destination of a vehicle in which the terminal apparatus is mounted and designation information designating a connection to the predetermined communication network, and to output information necessary for outputting information on a first route from the departure point through the area to the destination based on information received from the server apparatus in response to the designation information.

A method according to the present disclosure is a method of operating a system comprising a server apparatus and a terminal apparatus configured to transmit and receive information to and from each other, the terminal apparatus being mounted in a vehicle, the method including:

storing, by the server apparatus, information on an area in which the terminal apparatus mounted in the vehicle can connect to a predetermined communication network;

transmitting, by the terminal apparatus, information on a departure point and a destination of the vehicle in which the terminal apparatus is mounted and designation information designating a connection to the predetermined communication network; and

outputting, by the terminal apparatus, information on a first route from the departure point through the area to the destination based on information transmitted to the terminal apparatus by the server apparatus in response to the designation information.

A server apparatus and the like according to the present disclosure can increase convenience by performing a route search that satisfies a user's wishes in detail.

### BRIEF DESCRIPTION OF THE DRAWINGS

In the accompanying drawings:

FIG. 1 is a diagram illustrating an example configuration of an information processing system;

FIG. 2 is a diagram illustrating an example configuration of a server apparatus;

FIG. 3 illustrates an example configuration of a terminal apparatus;

FIG. 4A is a sequence diagram illustrating an operation example of the information processing system;

FIG. 4B is a sequence diagram illustrating an operation example of the information processing system;

FIG. 4C is a sequence diagram illustrating an operation example of the information processing system; and

FIG. 5 is a flowchart illustrating an operation example of the server apparatus and the terminal apparatus.

### DETAILED DESCRIPTION

Embodiments are described below.

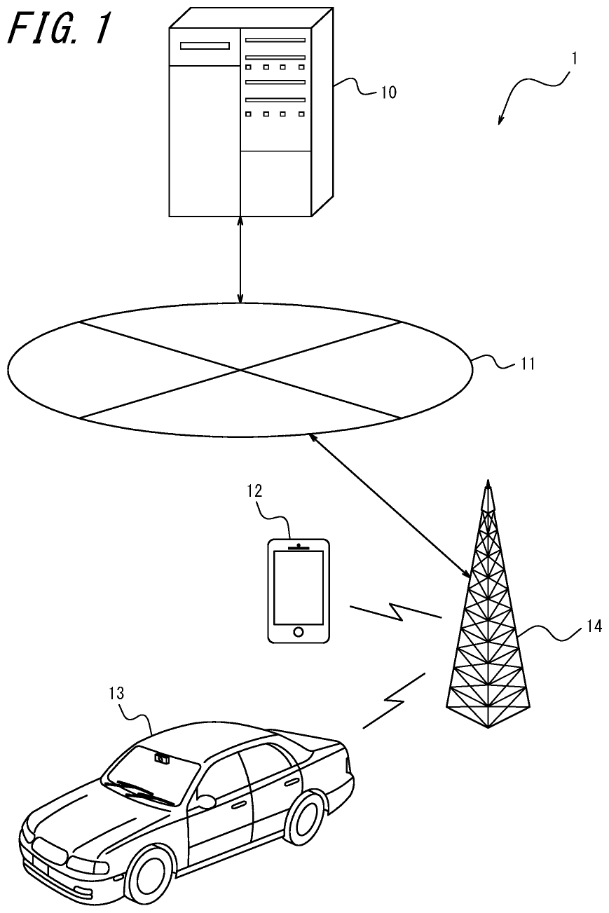

FIG. 1 is a diagram illustrating a configuration example of an information processing system according to an embodiment. An information processing system 1 includes one or more each of a server apparatus 10, a terminal apparatus 12, and a vehicle 13 communicably connected to each other via a public communication network 11, for example. The terminal apparatus 12 is used in a moving vehicle 13 by a user on board the vehicle 13. The terminal apparatus 12 and the vehicle 13 are connected to the public communication network 11 via one or more mobile communication networks 14. The server apparatus 10 is a computer that implements server functions. The terminal apparatus 12 is, for example, an information terminal apparatus such as a smartphone, a tablet terminal apparatus, or the like. Alternatively, the terminal apparatus 12 may be an on-board apparatus such as a navigation apparatus mounted in the vehicle 13. The vehicle 13 is a passenger car, a commercial vehicle, or the like that has, mounted therein, an on-board apparatus with a communication function and a positioning function and that is configured to transmit various information, including positional information, to the server apparatus 10 and to receive various information from the server apparatus 10. The vehicle 13 may be driven by a driver, or driving may be automated at any level, such as one of Level 1 to Level 5defined by the Society of Automotive Engineers (SAE). The public communication network 11 is the Internet, for example, but may also include an ad-hoc network, a LAN, a Metropolitan Area Network (MAN), other networks, or a combination of two or more thereof. The mobile communication network 14 is, for example, a mobile communication network implementing a communication methods such as long term evolution (LTE), 4th generation (4G), and 5th generation (5G).

A user of the terminal apparatus 12 can use various services by having the terminal apparatus 12 communicate with various servers, including the server apparatus 10, via the mobile communication network 14 and the public communication network 11. Such services include, for example, the distribution of video and other content, the provision of entertainment content such as online games, and the provision of various real-time information such as traffic information or road environment information that is collected on a server. A higher communication throughput is required for the mobile communication network 14 to transmit and receive larger amounts of data with lower latency in such systems. It is thus desirable for the terminal apparatus 12 to connect to a higher throughput mobile communication network 14. However, a mobile communication network 14 based on a new method becomes available in stages during a transitional period of technological progress in mobile communications. Areas that can connect to the mobile communication network 14 based on the old method (such as 4G) and areas that can connect to the mobile communication network 14 based on the new method (such as 5G) are therefore intermixed, and accessibility of the area based on the new method that can obtain high throughput may become limited (hereinafter, the area based on the old method with low communication throughput is referred to as the low throughput area, and the area based on the new method with high communication throughput is referred to as the high throughput area). On the other hand, the shortest or least expensive route from the departure point to the destination of the vehicle 13 may not necessarily pass through a high throughput area. In that case, the terminal apparatus 12 may not be able to acquire the desired communication throughput while the vehicle 13 is moving. With respect to this point, the information processing system 1 in the present embodiment can increase convenience by performing a route search that satisfies a user's wishes in detail when the user wishes to pass through a high throughput area to use a service that requires high communication throughput while traveling in the vehicle 13.

The server apparatus 10 of the present embodiment stores information on a high throughput area where the terminal apparatus 12 mounted in the vehicle 13 can connect to the mobile communication network 14 where a high communication throughput can be obtained. When the server apparatus 10 receives, from the terminal apparatus 12, information on the departure point and destination of the vehicle 13 and designation information designating a connection to the mobile communication network 14 where a high communication throughput can be obtained, the server apparatus 10 transmits, to the terminal apparatus 12, information on a route from the departure point through the high throughput area to the destination (throughput priority route). Alternatively, the server apparatus 10 transmits, to the terminal apparatus 12, information necessary to calculate and output the throughput priority route on the terminal apparatus 12. In this way, the route search satisfies the user's wishes, such as passing through a high throughput area, in detail. The terminal apparatus 12 can present the information on the throughput priority route to the driver of the vehicle 13 or transmit the information to an automated driving system of the vehicle 13, thereby enabling the vehicle 13 to travel to the destination while passing through the high throughput area. The convenience for the user can thereby be increased.

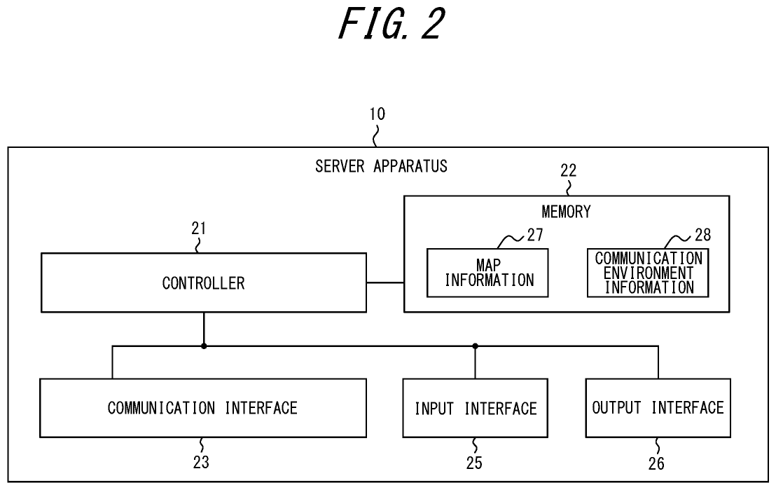

FIG. 2 illustrates an example configuration of the server apparatus 10. The server apparatus 10 includes a controller 21, a memory 22, a communication interface 23, an input interface 25, and an output interface 26.

The server apparatus 10 is, for example, a server computer that belongs to a cloud computing system or other computing system and functions as a server that implements various functions. The server apparatus 10 may be one or more server computers that are communicably connected to each other and operate in cooperation. For example, a server that stores communication environment information including information on high throughput areas and a server that performs a route search may be configured by a single server computer or by separate server computers.

The controller 21 includes one or more processors, one or more dedicated circuits, or a combination thereof. The processor is a general purpose processor, such as a central processing unit (CPU), or a dedicated processor specialized for particular processing, such as a graphics processing unit (GPU). The dedicated circuit is, for example, a field-programmable gate array (FPGA), an application specific integrated circuit (ASIC), or the like. The controller 21 executes processes pertaining to operations by the server apparatus 10 while controlling the components of the server apparatus 10.

The memory 22 includes, for example, one or more semiconductor memories, one or more magnetic memories, one or more optical memories, or a combination of at least two of these, which function as a main memory, an auxiliary memory, or a cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 22 stores information for use in operations of the server apparatus 10 and information resulting from operations of the server apparatus 10.

The communication interface 23 includes one or more interfaces for communication. The interface for communication is, for example, a LAN interface. The communication interface 23 receives information for use in operations of the server apparatus 10 and transmits information resulting from operations of the server apparatus 10. The server apparatus 10 is connected to the public communication network 11 via the communication interface 23 and communicates information with other apparatuses via the public communication network 11.

The input interface 25 includes one or more interfaces for input. The interface for input is, for example, a physical key, a capacitive key, a pointing device, a touchscreen integrally provided with a display, or a microphone that receives audio input. The input interface 25 accepts operations to input information used for operation of the server apparatus 10 and transmits the inputted information to the controller 21.

The output interface 26 includes one or more interfaces for output.

The interface for output is, for example, a display or a speaker. The display is, for example, a liquid crystal display (LCD) or an organic electro-luminescence (EL) display. The output interface 26 outputs information resulting from operations of the server apparatus 10.

The functions of the server apparatus 10 are realized by a processor included in the controller 21 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 21.

In the present embodiment, the memory 22 stores map information 27 and communication environment information 28. The controller 21 continually receives positional information, along with information indicating the communication status, from the moving vehicle 13 and stores the communication environment information 28, which associates the position and the communication status, in the memory 22. The communication status is information indicating the communication method of the mobile communication network 14 that can be connected to and includes a distinction between an old method with low throughput and a new method with high throughput. The communication environment information 28 thereby stores information that distinguishes between a low throughput area and a high throughput area in correspondence with each position. The controller 21 refers to the map information 27 and the communication environment information 28 when searching for a route from the departure point of the vehicle 13 to the destination in the procedure described below.

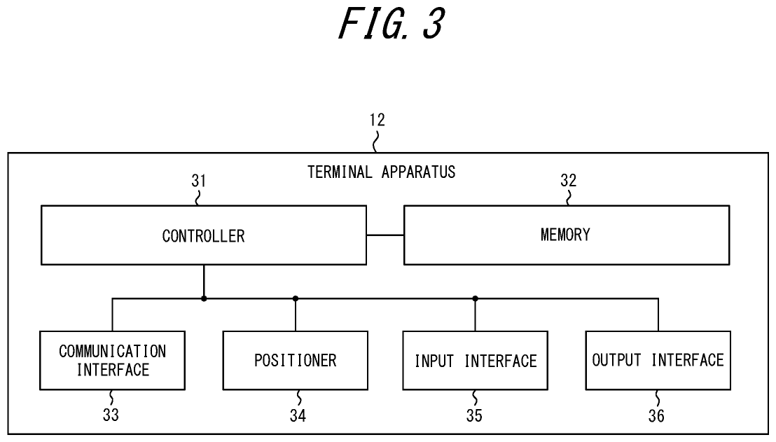

FIG. 3 illustrates an example configuration of the terminal apparatus 12 used by a user in the vehicle 13. The terminal apparatus 12 includes a controller 31, a memory 32, a communication interface 33, a positioner 34, an input interface 35, and an output interface 36. The terminal apparatus 12 is an information processing apparatus, such as a smartphone or a tablet terminal, or a vehicle-mounted apparatus such as a navigation apparatus. The terminal apparatus 12 may present the driver with the information necessary to control the operation of the vehicle 13 or may transmit the information necessary to control the operation to an automated driving apparatus of the vehicle 13. Alternatively, the terminal apparatus 12 may be configured integrally with the automated driving apparatus of the vehicle 13 and may implement at least a portion of automated driving control.

The controller 31 includes one or more processors, one or more dedicated circuits, or a combination thereof. The processor is a general purpose processor such as a CPU, or a dedicated processor that is dedicated to specific processing. The dedicated circuit is, for example, an FPGA or an ASIC. The controller 31 executes processes pertaining to operations of the terminal apparatus 12 while controlling the components of the terminal apparatus 12.

The memory 32 includes, for example, one or more semiconductor memories, one or more magnetic memories, one or more optical memories, or a combination of at least two of these, which function as a main memory, an auxiliary memory, or a cache memory. The semiconductor memory is, for example, RAM or ROM. The RAM is, for example, SRAM or DRAM. The ROM is, for example, EEPROM. The memory 32 executes information processing pertaining to operations of the terminal apparatus 12 and also stores information used in operations of the terminal apparatus 12 and information resulting from operations of the terminal apparatus 12.

The communication interface 33 includes one or more interfaces for communication. The interface for communication is, for example, an interface compatible with mobile communication standards such as LTE, 4G, and 5G. The communication interface 33 receives information for use in operations of the terminal apparatus 12 and transmits information resulting from operations of the terminal apparatus 12. The terminal apparatus 12 is connected to the mobile communication network 14 by the communication interface 33 via a base station for mobile communication and communicates information with other apparatuses over the mobile communication network 14.

At least one global navigation satellite system (GNSS) is included in the positioner 34. Global Positioning System (GPS), Quasi-Zenith Satellite System (QZSS), BeiDou, Global Navigation Satellite System (GLONASS), and/or Galileo is included in the GNSS. The positioner 34 acquires positional information for the terminal apparatus 12.

The input interface 35 includes one or more interfaces for input. The interface for input is, for example, a camera that captures images, a physical key, a capacitive key, a pointing device, a touchscreen integrally provided with a display, or a microphone that receives audio input. The input interface 35 accepts user operations to input information used for operation of the terminal apparatus 12 and transmits the inputted information to the controller 31 100301 The output interface 36 includes one or more interfaces for output.

The interface for output is, for example, a display or a speaker. The display is, for example, an LCD or an organic EL display. The output interface 36 outputs information resulting from operations of the terminal apparatus 12.

The functions of the terminal apparatus 12 are realized by a processor included in the controller 31 executing a control program. The control program is a program for causing a computer to execute the processing of steps included in operations of the terminal apparatus 12, thereby enabling the computer to realize the functions corresponding to the processing of the steps. That is, the control program is a program for causing the computer to function as the terminal apparatus 12. Some or all of the functions of the terminal apparatus 12 may be realized by a dedicated circuit included in the controller 31.

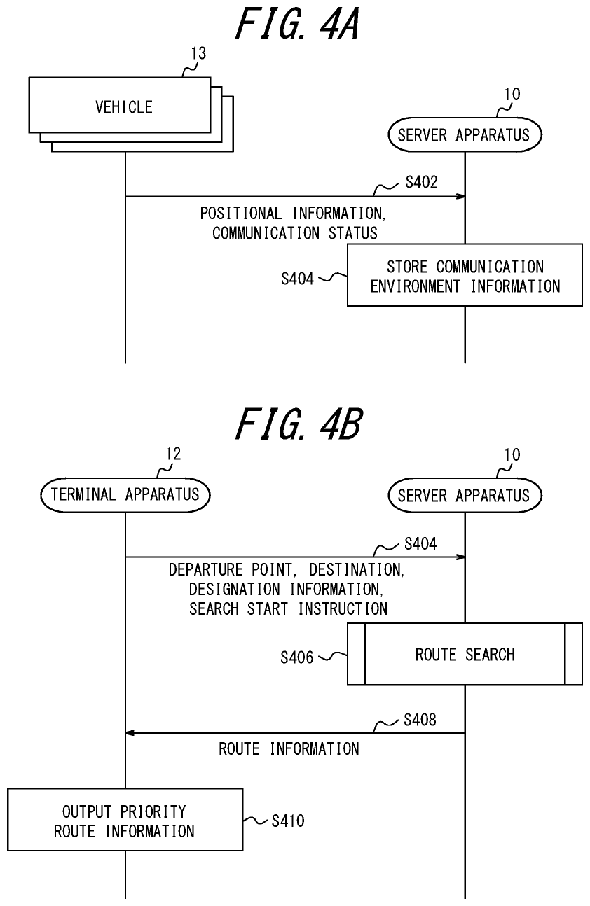

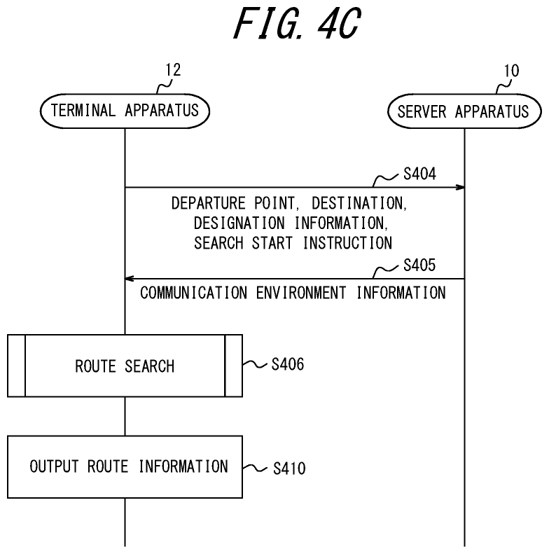

FIGS. 4A to 4C are sequence diagrams illustrating an operation example of the information processing system 1. FIG. 4A illustrates operating procedures by the server apparatus 10 and the vehicle 13, and FIG. 4B illustrates operating procedures by the server apparatus 10 and the terminal apparatus 12. FIG. 4C illustrates operating procedures by the server apparatus 10 and the terminal apparatus 12 in a variation of the procedures of FIG. 4B.

In FIG. 4A, steps S400 and S402 are performed in any appropriate cycle, such as a cycle of tens of seconds to several minutes, for each vehicle 13 when one or more vehicles 13 are traveling. In step S400, the vehicle 13 transmits the positional information and the information indicating the communication status to the server apparatus 10. In the server apparatus 10, the controller 21 receives the positional information and the information indicating the communication status via the communication interface 23. Then, in step S402, the server apparatus 10 stores the communication environment information 28. In the server apparatus 10, the controller 21 associates the positional information with the information indicating the communication status and stores the communication environment information 28 indicating the communication status for each position in the memory 22.

In FIG. 4B, steps S404 to S410 are performed once for each terminal apparatus 12 when one or more vehicles 13 start traveling.

In step S404, the terminal apparatus 12 transmits information indicating the departure point and the destination of the vehicle 13, designation information designating a connection to the high throughput mobile communication network 14, and an instruction to start searching for a route to the server apparatus 10. In the terminal apparatus 12, the controller 31 receives input of the departure point and the destination from the user via the input interface 25. The controller 31 may use the current position acquired from the positioner 34 as the departure point. The controller 31 also receives input from the user, via the input interface 35, designating a high throughput area and generates designation information designating connection to the high throughput mobile communication network 14. Furthermore, the controller 31 receives, via the input interface 35, input from the user instructing to start searching. The controller 31 then transmits, via the communication interface 33, information indicating the departure point and the destination, the designation information, and the search start instruction to the server apparatus 10. In the server apparatus 10, the controller 21 then receives, via the communication interface 23, the information indicating the departure point and the destination, the designation information, and the search start instruction.

The input designating a high throughput area is, for example, input of user preferences for the route search. For example, the controller 31 presents options for user preferences in the route search using the output interface 36. The options for user preferences in the route search include, for example, priorities such as travel time priority, toll priority, and communication speed priority. When communication speed priority is selected, the controller 31 accepts the selection as input designating a high throughput area and generates designation information including information that the communication speed priority has been selected. The input designating the high throughput area is, for example, input designating a service to be used by the user. For example, using the output interface 36, the controller 31 presents options for services to be used by the user. Service options include distribution of video and other content, online games, and receipt of various real-time information from a server. When a service requiring high throughput is selected, the controller 31 accepts the selection as input designating a high throughput area. In the terminal apparatus 12, the memory 32 stores information such as the required communication throughput, the allowable delay rate, and the amount of data to be transmitted and received for each service, for example, and the controller 31 determines the communication throughput in accordance with the selected service by referring to this information. The controller 31 then generates designation information that includes information about the service, such as the required throughput, the allowable delay rate, and the like for the selected service.

In step S406, the server apparatus 10 searches for a route from the departure point to the destination. In the server apparatus 10, the controller 21 searches for a throughput priority route, upon receiving the designation information, by referring to the map information 27 and the communication environment information 28 stored in the memory 22, according to the procedure described below. When not receiving the designation information, the server apparatus 10 searches for a normal route without regard for a condition of passing through the high throughput area.

In step S408, the server apparatus 10 transmits information on the searched route to the terminal apparatus 12. In the server apparatus 10, the controller 21 transmits information indicating the route to the terminal apparatus 12 via the communication interface 23. In the terminal apparatus 12, the controller 31 receives the information indicating the route via the communication interface 33.

In step S410, the terminal apparatus 12 outputs the information indicating the route. In the terminal apparatus 12, the controller 31 displays the route to the driver using the output interface 36. Alternatively, the controller 31 may transmit the information indicating the route to the automated driving system of the vehicle 13.

The procedures of the variation in FIG. 4C differ from the procedures of FIG. 4B in the following respects. In FIG. 4C, step S405 is added and step S408 is omitted. Furthermore, step S406 is executed by the terminal apparatus 12.

Step 5404 is the same as step S404 in FIG. 4B. Next, in step S405, the server apparatus 10 transmits the communication environment information 28 to the terminal apparatus 12 in response to the designation information. In other words, the server apparatus 10 transmits, to the terminal apparatus 12, the information necessary for the terminal apparatus 12 to output information on the throughput priority route from the departure point to the destination through the high throughput area. In the server apparatus 10, the controller 21 reads the communication environment information 28 from the memory 32 and transmits the read information to the terminal apparatus 12 via the communication interface 23. At this time, the controller 31 may extract the communication environment information 28 corresponding to the areas including the departure point and the destination and transmit the extracted information to the terminal apparatus 12. In the terminal apparatus 12, the controller 31 then receives the communication environment information 28 via the communication interface 33 and stores the received information in the memory 32.

In step S406, the terminal apparatus 12 searches for a route from the departure point to the destination. In the terminal apparatus 12, the controller 31 searches for a throughput priority route by referring to the map information stored in the memory 32 and the communication environment information 28 received from the server apparatus 10, according to the procedure described below. When not receiving input designating a high throughput area, the terminal apparatus 12 searches for a normal route without regard for a condition of passing through the high throughput area.

Then, in step S410, the terminal apparatus 12 outputs information indicating the route.

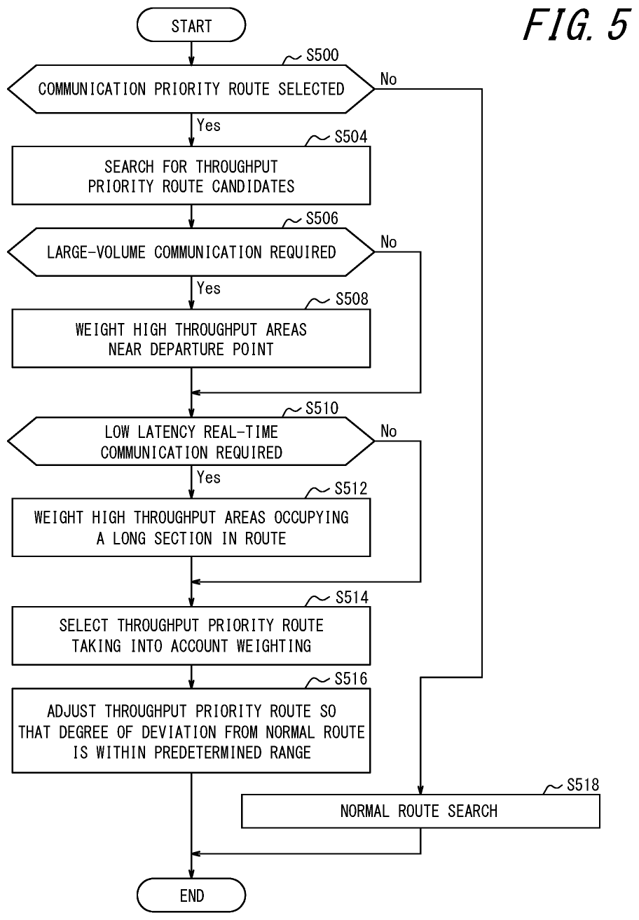

FIG. 5 is a flowchart illustrating a detailed procedure of the processing in step S406 by the controller 21 of the server apparatus 10 or the controller 31 of the terminal apparatus 12. For the sake of convenience, the processing is described as a processing procedure for the controller 21 of the server apparatus 10, but the same description applies to the controller 31 of the terminal apparatus 12.

In step S500, the controller 21 judges whether the user has selected a communication priority route. When information indicating that the communication priority route has been selected is included in the designation information, the controller 21 judges that the user has selected the communication priority route (Yes) and advances to step S504. Conversely, when information indicating that the communication priority route has been selected is not included, the controller 21 judges that the user did not select the communication priority route (No) and advances to step S518.

In step S504, the controller 21 searches for a candidate throughput priority route. The controller 21 refers to the communication environment information 28 and uses any appropriate algorithm to search for a route from the departure point through the high throughput area to the destination. At this time, one or more route candidates such that at least part of the route passes through the high throughput area are searched for. It suffices for the route candidate to be such that one or more sections on the route from the departure point to the destination passes through the high throughput area.

In step S506, the controller 21 judges whether large-volume communication is required. When information on the selected service is included in the designation information, the controller 21 judges whether the amount of data to be transmitted and received for the service is equal to or greater than a freely set reference. If the amount of data to be transmitted and received is equal to or greater than the reference, the controller 21 judges that large-volume communication is necessary (Yes) and advances to step S508. Services that require large-volume communication include, for example, the reception of game programs or content such as videos. When the amount of data to be transmitted or received is less than the reference amount, the controller 21 judges that large-volume communication is unnecessary (No), omits step S508, and advances to step S510.

In step S508, the controller 21 weights the high throughput areas near the departure point among the high throughput areas through which the candidate throughput priority routes pass. For example, the controller 21 assigns a score to the high throughput areas through which the route candidates pass. At this time, since the use of a service that requires large-volume communication has been selected, it is preferable to pass through a high throughput area while still near the departure point in order to finish receiving data on the first half of the route and enable the service to be used without interruption for the remainder of the journey. Therefore, the controller 21 weights the score so that the score increases closer to the departure point.

In step S510, the controller 21 judges whether low latency real-time communication is required. When information on the selected service is included in the designation information, the controller 21 judges whether the allowable delay rate for the service is equal to or less than a freely set reference. The controller 21 determines that real-time communication is necessary if the allowable delay rate is equal to or less than the reference (Yes) and advances to step S512. Services that require real-time communication include, for example, games that are played in a communication environment with other terminal apparatuses, services to provide traffic information including notifications such as the position of other vehicles, and the like. If the allowable delay rate for the service exceeds the reference, the controller 21 judges that real-time communication is unnecessary (No), omits step S512, and advances to step S514.

In step S512, the controller 21 weights the high throughput areas, among the high throughput areas through which the throughput priority routes pass, that occupy a long section in each route. For example, the controller 21 assigns a score to one or more high throughput areas through which a route passes. If the route passes through a plurality of high throughput areas, a score is assigned to each area. At this time, it is preferable to pass through high throughput areas as consecutively as possible, since use of a service requiring real-time communication has been selected. The controller 21 therefore weights the score to be higher as the section in the route candidate is longer.

In step S514, the controller 21 selects an optimal throughput priority route from among the throughput priority route candidates, taking into account the weighting. For example, the controller 21 accumulates the scores assigned to the high throughput areas through which each throughput priority route candidate passes and selects the candidate with the highest score as the optimal throughput priority route. A throughput priority route that optimally satisfies the need for large-volume or low-latency communication is thus selected.

In step S516, the controller 21 adjusts the throughput priority route so that the degree of deviation from a normal route is within a reference range.

Normal routes are routes that lead from the departure point to the destination without any designation information being generated, i.e., without the condition of passing through a high throughput area. Such routes include the route with the shortest travel time and the route with the lowest tolls. When compared to these normal routes, throughput priority routes may significantly increase travel time, travel distance, or tolls in an attempt to pass through high throughput areas. In other words, the degree of deviation of the throughput priority route from the normal route may increase. The degree of deviation is, for example, the excess travel time for the throughput priority route compared to the route with the shortest travel time, the excess travel distance for the throughput priority route compared to the route with the shortest distance, or the excess travel tolls for the throughput priority route compared to the route with the lowest tolls. The controller 21 establishes any appropriate reference range for the degree of such deviation and adjusts the throughput priority route so that the degree of deviation falls within the reference range. For example, when the throughput priority route passes through a plurality of high throughput areas with different assigned scores, the controller 21 can change the route to pass through low throughput areas by omitting high throughput areas, starting with the area having the lowest score. A balance can thus be achieved between minimizing the time, distance, or cost of travel and meeting the need to pass through a high throughput area.

After executing step S516, the controller 21 ends the procedures of FIG. 5. When judging in step S500 that the user did not select a communication priority route in step S500 (No), the controller 21 executes a normal route search in step S518 and ends the procedures of FIG. 5.

As described above, the present embodiment can increase convenience by performing a route search that that satisfies, in detail, a user's wish to pass through a high throughput area in order to use a service that requires high communication throughput.

In the case described above, the designation information transmitted from the terminal apparatus 12 to the server apparatus 10 includes information on the service to be used on the terminal apparatus 12. In one variation, user identification information stored in the terminal apparatus 12 may be included in the identification information, and the frequency with which the user selects the throughput priority route or the history of frequently used services may be accumulated in the server apparatus 10 in association with the identification information of the user. The server apparatus 10 may then be configured to learn the preferences of the user. With this approach, if the designation information includes user identification information, then a throughput priority route passing through a high throughput area can be calculated by determining the user's preference on the server apparatus 10, even if information on the service or the like is not included in the designation information, for example. The designation information including the user identification information in this case corresponds to the designation information designating a connection to the high throughput mobile communication network 14.

In the above embodiment, a processing/control program that specifies operations of the terminal apparatus 12 may be stored in the memory 22 of the server apparatus 10 or in the memory of another server apparatus and be downloaded onto each apparatus via the public communication network 11. The processing/control program may also be stored on a non-transitory recording/storage medium readable by the terminal apparatus 12, and each apparatus may read the program from the medium.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface;
a memory configured to store information on an area in which a terminal apparatus mounted in a vehicle can connect to a predetermined communication network; and
a controller configured to transmit and receive information to and from the terminal apparatus via the communication interface, wherein
upon receiving, from the terminal apparatus, information on a departure point and a destination of the vehicle and designation information designating a connection to the predetermined communication network, the controller is configured to transmit, to the terminal apparatus, information necessary for the terminal apparatus to output information on a first route from the departure point through the area to the destination.

2. The server apparatus of claim 1, wherein the designation information is transmitted from the terminal apparatus in response to a predetermined input by a user to the terminal apparatus.

3. The server apparatus of claim 1, wherein
the designation information includes information on a service to be used on the terminal apparatus, and
the controller is configured to calculate the first route, based on the information on the service, so that the vehicle passes through the area during a period when the terminal apparatus is to connect to the predetermined communication network.

4. The server apparatus of claim 1, wherein the controller is configured to calculate the first route so that a degree of deviation of the first route from a second route, calculated when the designation information is not received, from the departure point to the destination is within a predetermined range.

5. The server apparatus of claim 1, wherein the information on the area is transmitted from another terminal apparatus mounted in another vehicle and connected to the predetermined communication network.

6. The server apparatus of claim 1, wherein the terminal apparatus is capable of communicating information at a higher communication throughput rate when connecting to the predetermined communication network than when connecting to another communication network to which the terminal apparatus can connect outside the area.

7. A terminal apparatus comprising:
a communication interface;
a controller configured to transmit and receive information, via the communication interface, to and from a server apparatus storing information on an area in which the terminal apparatus can connect to a predetermined communication network; and
an output interface configured to output information received from the controller, wherein
the controller is configured to transmit, to the server apparatus, information on a departure point and a destination of a vehicle in which the terminal apparatus is mounted and designation information designating a connection to the predetermined communication network, and to output information necessary for outputting information on a first route from the departure point through the area to the destination based on information received from the server apparatus in response to the designation information.

8. The terminal apparatus of claim 7, wherein
the designation information includes information on a service to be used, and
the controller is configured to calculate the first route, based on the information on the service, so that the vehicle passes through the area during a period when the terminal apparatus is to connect to the predetermined communication network.

9. The terminal apparatus of claim 8, wherein
the designation information includes information on a service to be used, and
the controller is configured to calculate the first route, based on the information on the service, so that the vehicle passes through the area during a period when the terminal apparatus is to connect to the predetermined communication network.

10. The terminal apparatus of claim 7, wherein the controller is configured to calculate the first route so that a degree of deviation of the first route from a second route, calculated when the designation information is not transmitted to the server apparatus, from the departure point to the destination is within a predetermined range.

11. The terminal apparatus of claim 7, wherein the information on the area is transmitted to the server apparatus from another terminal apparatus mounted in another vehicle and connected to the predetermined communication network.

12. The terminal apparatus of claim 7, wherein the terminal apparatus is configured to communicate information at a higher communication throughput rate when connecting to the predetermined communication network than when connecting to another communication network to which the terminal apparatus can connect outside the area.

13. A non-transitory computer readable medium storing a program which, when executed by a terminal apparatus, causes the terminal apparatus to operate as the terminal apparatus of claim 7.

14. A vehicle having the terminal apparatus of claim 7 mounted therein.

15. A method of operating a system comprising a server apparatus and a terminal apparatus configured to transmit and receive information to and from each other, the terminal apparatus being mounted in a vehicle, the method comprising:
storing, by the server apparatus, information on an area in which the terminal apparatus mounted in the vehicle can connect to a predetermined communication network;
transmitting, by the terminal apparatus, information on a departure point and a destination of the vehicle and designation information designating a connection to the predetermined communication network; and
outputting, by the terminal apparatus, information on a first route from the departure point through the area to the destination based on information transmitted to the terminal apparatus by the server apparatus in response to the designation information.

16. The method of claim 15, wherein the designation information is transmitted from the terminal apparatus to the server apparatus in response to a predetermined input by a user to the terminal apparatus.

17. The method of claim 15, wherein
the designation information includes information on a service to be used on the terminal apparatus, and
the method further comprises calculating, by the server apparatus or the terminal apparatus, the first route based on the information on the service, so that the vehicle passes through the area during a period when the terminal apparatus is to connect to the predetermined communication network.

18. The method of claim 15, further comprising calculating, by the server apparatus or the terminal apparatus, the first route so that a degree of deviation of the first route from a second route, calculated when the designation information is not received, from the departure point to the destination is within a predetermined range.

19. The method of claim 15, further comprising receiving, by the server apparatus, the information on the area from another terminal apparatus mounted in another vehicle and connected to the predetermined communication network.

20. The method of claim 15, wherein the terminal apparatus is capable of communicating information at a higher communication throughput rate when connecting to the predetermined communication network than when connecting to another communication network to which the terminal apparatus can connect outside the area.
